(19) United States
(12) Patent Application Publication
(10) Pub. No.: US 2019/0322509 A1
(43) Pub. Date: Oct. 24, 2019

(54) Frame For A Pallet Truck

(71) Applicant: Zhejiang E-P Equipment Co., Ltd., Hangzhou (CN)

(72) Inventors: Kang Jianming, Hangzhou (CN); Chen Jianwei, Hangzhou (CN); Liu Yuanwei, Hangzhou (CN)

(21) Appl. No.: 16/387,235

(22) Filed: Apr. 17, 2019

(30) Foreign Application Priority Data
Apr. 19, 2018 (CN) 201820562673.X

(51) Int. Cl. B66F 9/075; B62B 3/06; B66F 9/065; H01M 2/10

(52) U.S. Cl. CPC B66F 9/07531; B62B 3/0618; H01M 2220/20; H01M 2/1083; B66F 9/065

(57) ABSTRACT

A frame for a pallet truck includes a frame body, a fork connected to and extending longitudinally from a front of the frame body. The frame body includes a frame housing, a front cover and a top block; with the top block connected to the rear face of the frame housing. The frame housing has an inner cavity with a forward facing opening and a partition wall divides the inner cavity into a battery cavity and an electrical components cavity.

### CROSS-REFERENCE TO RELATED APPLICATION

This application claims priority to Chinese Patent Application No. 201820562673.x, filed Apr. 19, 2018, which is hereby incorporated by reference in its entirety.

### TECHNICAL FIELD

The invention relates to material handling equipment, and more particularly to pallet trucks and frame components for pallet trucks.

### BACKGROUND

Industrial material handling equipment, such as a vehicle in the form of a pallet truck, usually is used in warehouses, factories, shipping terminals and related facilities. In those places, pallets, large parcels, or cargo loads need to be transported from one place to another. Material handling trucks, commonly known as a pallet forklift or pallet truck, typically include a longitudinally extending, load-bearing fork and are used to lift a pallet or package for transportation. It is common for such vehicles to include an electric motor, steering control mechanism and brake to enable a user to drive and otherwise operate the vehicle. A variety of electrical components are installed in the frame of such a pallet truck, to facilitate control of the operation and shutdown of the vehicle. However, the current structure of a typical pallet truck includes an internal frame that is equipped with an installation chamber or cavity, and the electrical components are installed independently and in a disorganized manner on the side walls of the cavity. The frame of the typical pallet truck does not provide for an orderly layout of the internal electrical components, which makes assembly, service and repairs cumbersome.

### SUMMARY

One of the purposes of this disclosure is to provide a pallet truck and its frame, which benefits from installing one or more batteries and electrical components in different areas of relative isolation within the frame. The components are arranged along internal parts of the frame and are of reasonable construction, which permits standardizing of the layout and advantageously provides for more rapid and convenient maintenance.

In order to achieve this, the disclosure provides a carriage frame of a transport vehicle including a frame body and a longitudinally extending fork assembly connected to a front end of the frame body. The carriage frame is constructed so that the frame body includes a frame housing, a front cover and a top block. The top block has an inner cavity and is connected to a rear face of the frame housing. The frame housing has an inner cavity with an opening of the inner cavity facing forward. A partition wall is arranged in the frame housing to divide the inner cavity into a battery cavity and an electrical components cavity. The partition wall is provided with a first through hole connecting the battery cavity and the electrical components cavity. A second through hole is provided in the frame housing to further connect the electrical components cavity and the inner cavity of the top block.

In the preferred embodiment, the partition wall is a longitudinally arranged separator, which divides the inner cavity into left and right cavities, which form the respective battery cavity and electrical components cavity.

Also in the preferred embodiment, the bottom of the battery cavity is provided with a battery support plate, and a socket is arranged on the frame housing at the top of the battery cavity.

Further, with the preferred embodiment, the bottom of the electrical components cavity is provided with a support plate for a hydraulic supply system.

The disclosure provides a material handling transport vehicle, which is shown, for example, in the form of a pallet truck and its frame. The frame includes a frame housing having an inner cavity with a forward facing opening, and a top block having an inner cavity is connected to a rear face of the frame housing. The inner cavity of the frame housing is divided into a battery cavity and an electrical components cavity, which are separated by a partition wall. A battery and electrical components are installed in the respective cavities. Further, the partition wall is provided with a first through hole for connecting the battery cavity and the electrical components cavity. The first through hole provides a circuit path hole between the battery and the electrical components. A second through hole is arranged on the frame housing to further connect the electrical components cavity and the top block inner cavity, and the second through hole provides a hydraulic path hole for the conduit between the hydraulic lift cylinder, which is connected to the top block, and the hydraulic supply system. The above technical scheme is conducive to installing batteries and electrical components in different areas of relative isolation, permitting the internal parts of the frame to be of reasonable construction, with a standardized layout, and facilitating rapid replacement, service and maintenance.

### DESCRIPTION OF THE DRAWINGS

FIG. 1 is a schematic diagram of a pallet truck in accordance with the present disclosure.

FIG. 2 is a structural diagram of a frame of the pallet truck of FIG. 1, with a front cover removed.

FIG. 3 is a structural diagram of the frame of the pallet truck of FIGS. 1-2, with the front cover installed.

FIG. 4 is a schematic diagram of an arrangement of electrical components on the frame of the pallet truck of FIGS. 1-3.

FIG. 5 is a schematic diagram of an electrical bracket assembly of the pallet truck of FIGS. 1-4.

FIG. 6 is an assembly diagram of a bearing bridge and a drive system and lift cylinder of the pallet truck of FIGS. 1-4.

FIG. 7 is an assembly diagram of the bearing bridge of FIG. 6, including a rear enclosure plate, caster wheel brackets and caster wheels of the pallet truck of FIGS. 1-4.

FIG. 8 is an assembly diagram of a rear enclosure plate, including the caster wheel brackets and caster wheels of the pallet truck of FIGS. 1-4.

FIG. 9 is an assembly diagram of the rear enclosure plate and the caster wheel brackets of the pallet truck of FIGS. 1-4.

FIG. 10 is a schematic diagram of a handle connection structure connected to the drive system of the pallet truck of FIGS. 1-4.

FIG. 11 is a schematic diagram of a handle joint device of the pallet truck of FIGS. 1-4.

FIG. 12 is a schematic diagram of an elastic ejector assembly used in the handle joint device of FIG. 11 on the pallet truck of FIGS. 1-4.

### DETAILED DESCRIPTION OF THE PREFERRED EMBODIMENT

An embodiment of a material handling vehicle in the form of a pallet truck is described in detail below, and an example of the embodiment is shown in the drawings in which identical or similar labels throughout represent identical or similar elements, or elements with the same or similar functions. The following embodiments described with reference to the drawings are illustrative and are intended to be used to explain, rather than to limit the disclosure.

In the description of the preferred embodiment, it will be appreciated that the relative directions or positions with respect to the terms “up”, “down”, “front”, “back”, “left”, “right”, “top”, “bottom”, “inside” and “outside” are based on the position of the invention as shown in the drawings and are only for the convenience of describing the invention and simplifying the description, and do not narrow the scope of the appended claims. The term “releasable connection” refers to any form of connection, such as snap connection or screw connection, which may be separated without destroying the connection structure.

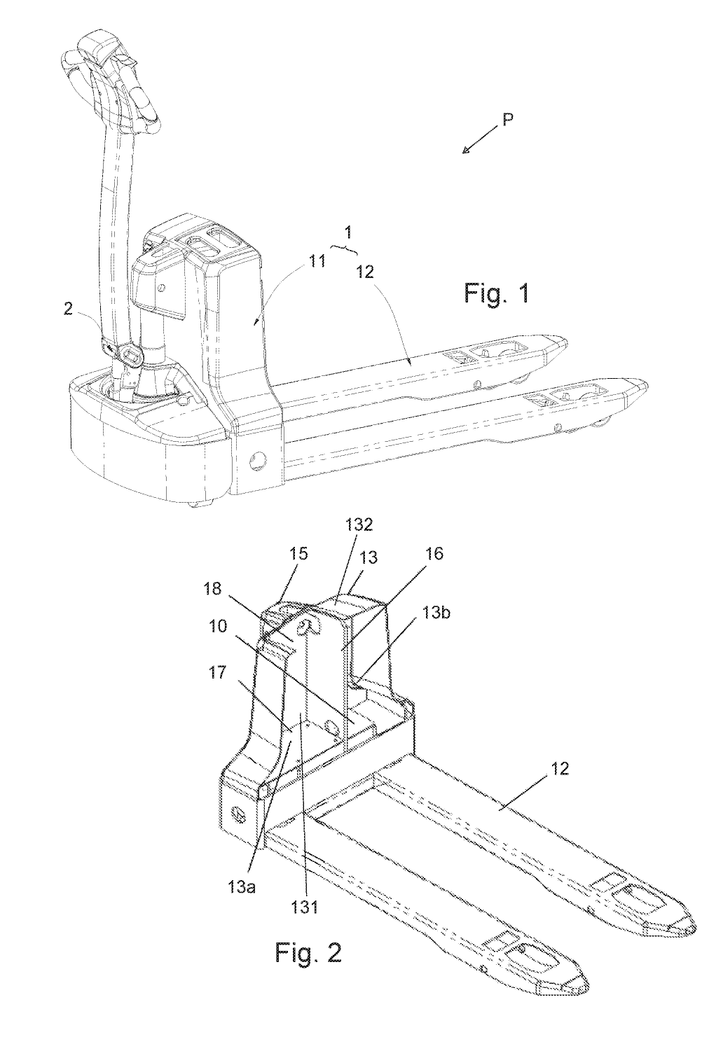

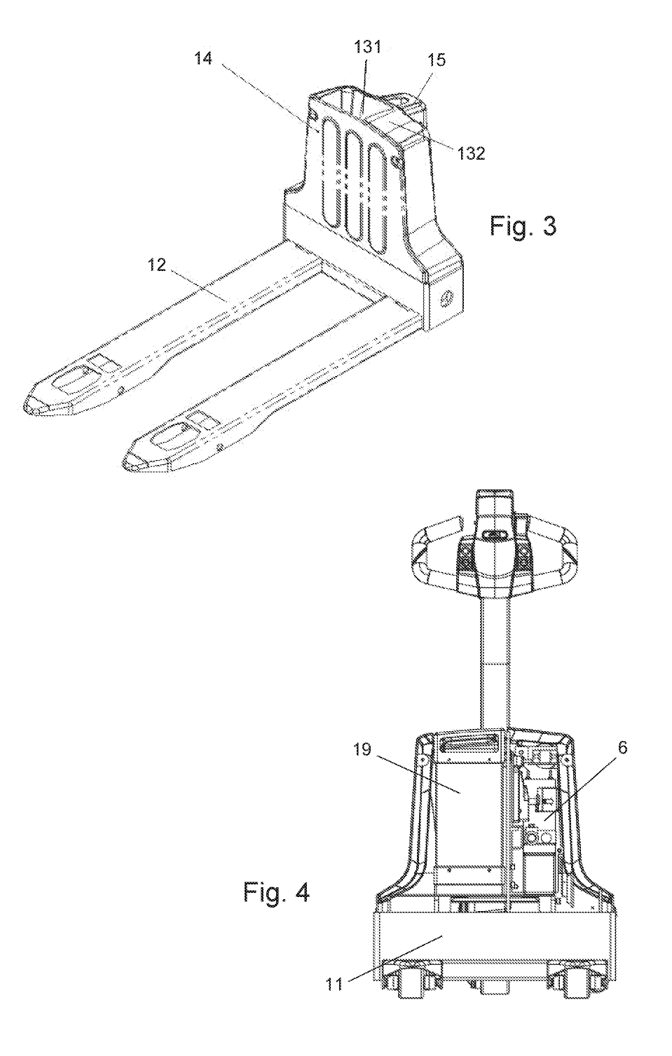

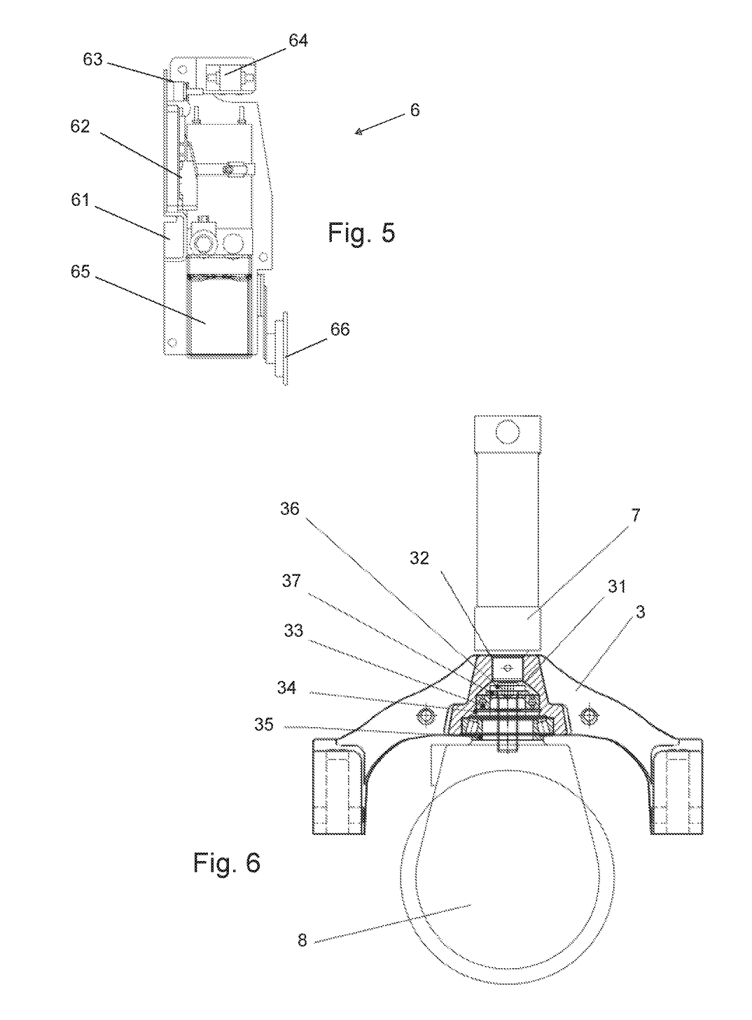

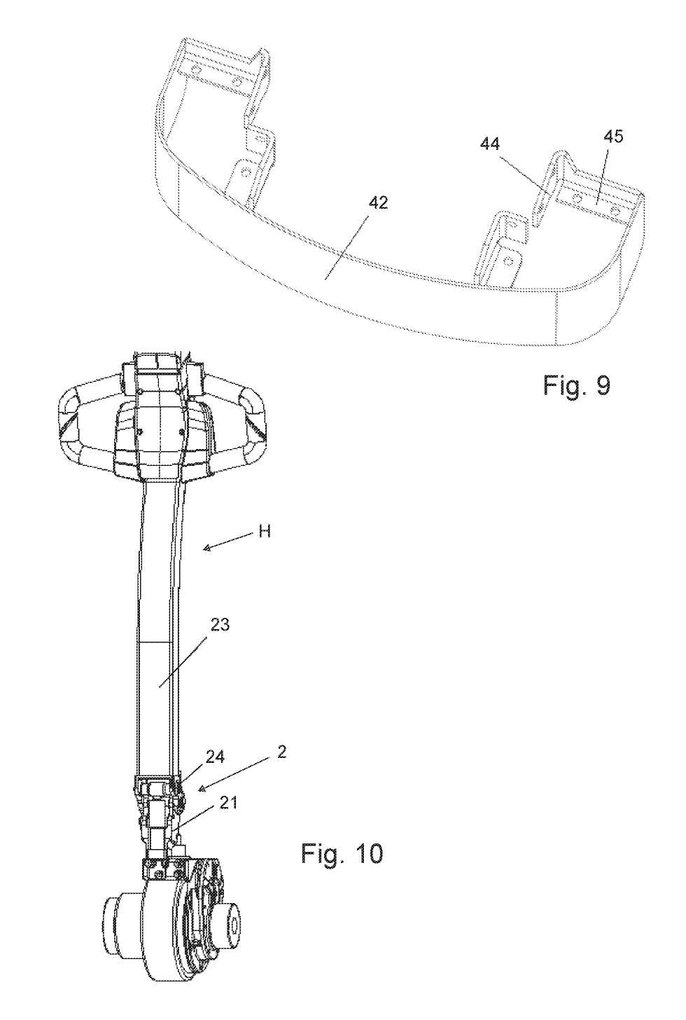

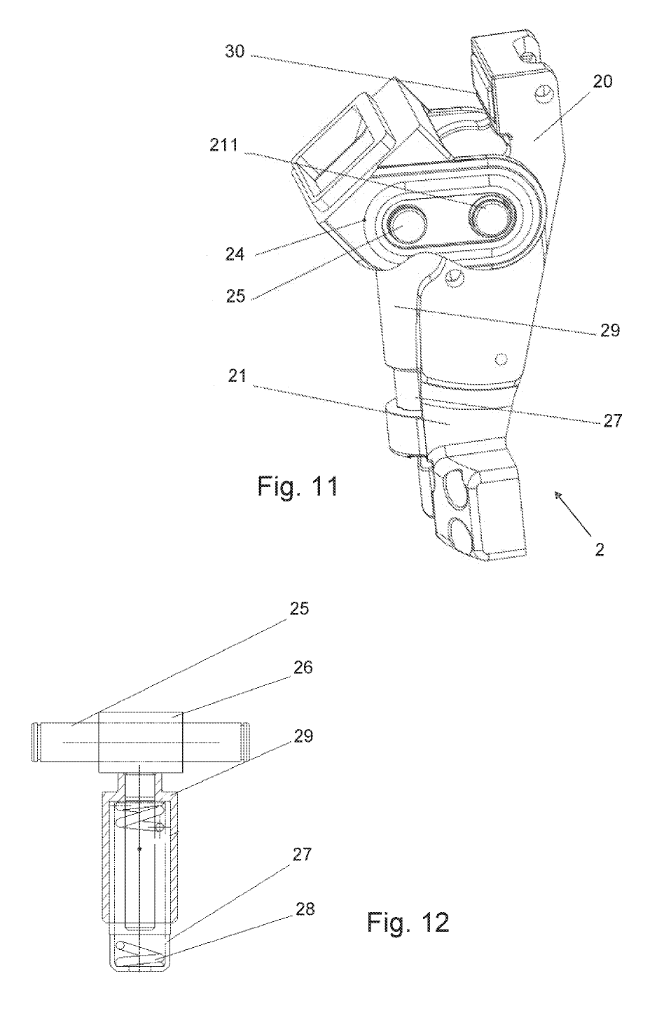

A material handling vehicle is shown in FIGS. 1-12, in the form of a pallet truck P. The vehicle P includes a frame 1, a handle joint device 2 and load bridge 3 connected to the frame 1. Caster wheel brackets 4 are connected to the load bridge 3 via a caster wheel assembly 5, and an electrical bracket assembly 6 is connected to the frame 1. The frame 1 includes a frame body 11 and a longitudinally extending fork 12 connected to the front end of the frame body 11.

The frame body 11 includes a frame housing 13, a front cover 14 and a top block 15. The top block 15 is connected to a rear face of the frame housing 13. An inner cavity of the frame housing 13 is provided with a forward facing opening. The front cover 14 is releaseably connected to the front of the frame housing 13 and covers the opening of the inner cavity. The rear face of the frame housing 13 can be molded with the forward facing opening. The front cover 14 is used to cover the forward facing opening of the inner cavity. When installed, the front cover 14 may be contacted by cargo that is placed on the front fork 12 of the pallet truck P. The example vehicle avoids the occurrence of contact damage between the frame and the cargo common with prior art pallet trucks, and the appearance of the frame 1 may be more stylish. After the front cover 14 is opened, the battery and electrical components are clearly visible at a glance, and the disassembly, replacement and maintenance of the electrical components are more convenient.

Further, the inner part of the frame housing 13 is provided with a partition wall 16, which divides the inner cavity into a battery cavity 13a and an electrical components cavity 13b. The partition wall 16 is a longitudinally arranged separator that divides the inner cavity into left and right cavities. A first through hole is arranged on the partition wall 16 to connect the battery cavity 13a with the electrical components cavity 13b, and a second through hole is arranged on the frame housing 13 to connect the electrical components cavity 13b with the top block 15. The bottom of the battery cavity 13a is provided with a battery support plate 17, and the top of the battery cavity 13a of the frame housing 13 is provided with an upward opening outlet 18. The battery cavity 13a is equipped with a battery body 19.

The battery body 19 is configured to provide a plug-in and pull-out battery. The battery body 19 can be inserted or withdrawn from the battery cavity 13a from the outlet 18. The battery support plate 17 is provided with a male battery base having an upward facing socket, the lower end of the battery body 19 is provided with a female receptacle having a downward facing connector in its lower end, and the female receptacle is connected with the male battery base. The plug-in battery body installation method is referred to in text previously submitted by the applicant in Chinese Application No. 201610896611.8. With this configuration, the inner part of the frame housing 13 is provided with a partition wall 16, which divides the inner cavity into a battery cavity 13a and an electrical components cavity 13b, and divides the inner cavity into the battery cavity 13a and an electrical components cavity 13b for installing batteries and electrical components, respectively, in isolation. Further, a first through hole is arranged on the partition wall 16 for connecting the battery cavity 13a and the electrical cavity 13b, and the first through hole provides a circuit path hole between the battery and the electrical components. A second through hole is arranged at the rear of the internal cavity of the frame housing 13 to connect the electrical components cavity 13b with the inner cavity of the top block 15, and the second through hole provides a further conduit route hole between the hydraulic supply system and a lift cylinder 7 connected to the top block 15. The frame 1 is conducive to installing batteries and electrical components in different areas of relative isolation, so that the internal parts of the frame 1 are reasonably separated and their layout may be standardized.

The bottom of the electrical components cavity 13b is provided with a hydraulic supply system support plate 10, and the electrical components cavity 13b is provided with an electrical support assembly 6, which comprises a base plate 61 and electrical components arranged on the base plate 61. The electrical components may include, for example, a controller 62, a fuse block 63, an emergency stop switch 64, a hydraulic supply system 65 and a loudspeaker 66. This configuration concentrates all of the useful electrical components of the vehicle onto one base plate 61 to form the electrical support assembly 6, and establishes modularization of the electrical components.

The base plate 61 of the electrical support assembly 6 is removably connected to the frame 1. When the base plate 61 is disassembled from the frame 1, the electrical components on the base plate 61 conveniently also may be maintained or replaced, so that the rapid disassembly and replacement of the electrical parts can be realized, which solves the complex problem of the electrical maintenance and replacement of the conventional electrical components of the transport vehicle, and reduces the size of the vehicle.

In the above-described configuration, the frame housing 13 and the top block 15 may be molded or stamped together to form an integral piece. The frame housing 13 includes a rear panel 131 and an enclosure 132 is arranged along the inner side of the rear panel 131. The partition wall 16 is connected to the rear panel 131 and serves as one wall of the enclosure 132, and is used to enhance the strength of the frame housing 13. In this configuration, the frame body 11 may be formed by stamping, and the top block 15 is connected to the rear face of the frame body 11. In order to ensure the overall strength of the frame body 11, the partition wall 16 is arranged in the inner cavity of the frame body 11. This structure improves the overall support strength of the frame body 11, and simplifies and improves the efficiency of producing the frame body 11.

Turning to FIG. 6, an inner part of the load bridge 3 is provided with a bearing cavity 31 for containing a bearing assembly. Located at an upper end of the bearing cavity 31 on the load bridge 3 is a base opening 32 that receives a lower end of a lift cylinder 7. A side wall of the bearing cavity 31 is closed. When the lift cylinder 7 is assembled in the base opening 32, the base opening 32 is closed. The bearing assembly includes a first bearing 33, a baffle 34 and a second bearing 35 arranged sequentially from top to bottom, and the baffle 34 is used to locate the first bearing 33. The axis of rotation of a drive system 8 is vertically aligned with a center of the second bearing 35, the baffle 34 and the first bearing 33, respectively. An upper end of a rotating shaft of the drive system 8 is provided with an internal thread groove, and the internal thread groove is connected with a locking bolt 36. The locking bolt 36 locks the bearing assembly, and a clamping plate 37 is arranged between the end of the locking bolt 36 and the first bearing 33.

As shown in FIG. 6, the assembly steps of the load bridge 3 include assembling the locking bolt 36 and clamping plate 37, which are received in the bearing cavity of the load bridge 3. Then, the first bearing 33 (such as a deep groove ball bearing) is assembled and the retainer ring 34 is used to limit the position of the first bearing 33. In addition, the second bearing 35 (such as a tapered roller bearing) and the drive system 8 are pre-assembled and then connected to respective assembly of the load bridge 3. During the process of tightening the locking bolt 36, the driving system 8 is slowly pressed into the load bridge 3, until the assembly is completed. Finally, the lift cylinder 7 is assembled to the top of the load bridge 3 by inserting its lower end into the base opening 32, to complete the assembly. In the load bridge 3, the base of the lift cylinder 7 is located in the base opening 32, directly above the bearing cavity 31. On the one hand, compared with a traditional load bridge, the load bridge 3 provides a simplified structure and helps to reduce the size of the pallet truck P. The pallet truck P has a reduced size and volume, an improved appearance and improved performance and operational comfort for the user. On the other hand, the installation position of bearing assembly is changed from an open type to closed type. Locking bolt 36 is installed with guidance and is more convenient to install. The bearing space is relatively closed after assembling the lift cylinder 7, which can greatly reduce the influence of dust and iron filings on bearing life.

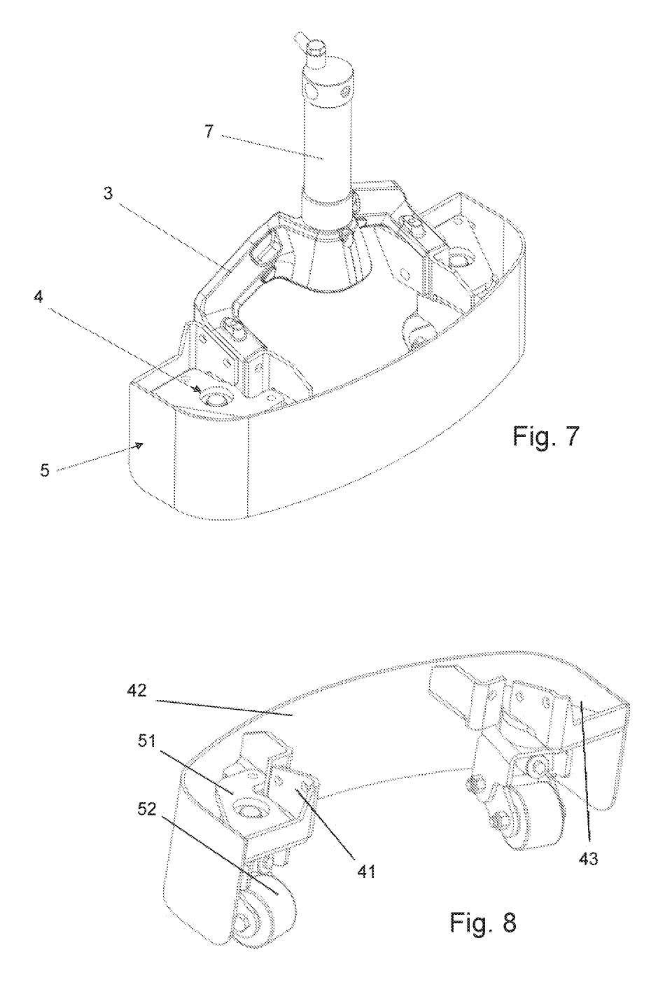

Turning to FIGS. 7-9, caster wheel brackets 4 include support brackets 41 connected at two ends of the caster wheel assembly 5, which includes a rear enclosure plate 42 that is connected to the sides of the two support brackets 41. The support brackets 41 and the rear enclosure plate 42 define openings 43 for installation of the caster wheel assemblies, which are installed and/or removed from above the opening 43. Each support bracket 41 includes a longitudinal portion 44 that is connected to the load bridge 3, such as by at least one screw or other suitable fastener, and a horizontal portion 45 of the support bracket 41 is used to receive and connect a caster wheel assembly, such as by at least one screw or other suitable fastener. Each caster wheel assembly includes a flange plate 51 and a caster wheel 52 extending downward from and rotatably connected via a rotatable shaft to the flange plate 51. The flange plate 51 and the horizontal portion 45 of the support bracket 41 may be connected, such as by at least one screw or other suitable fastener, and during installation, the caster wheel 52 passes through the opening 43 and is located below the caster wheel bracket 4.

The caster wheel brackets 4 are connected to the load bridge 3, and the caster wheel assemblies are installed on the caster wheel brackets 4. The caster wheel assemblies and caster wheel brackets 4 advantageously form a top-down installation mode. This solves problems associated with current bottom-up replacement modes of common pallet trucks where caster wheel assembly replacement requires a pallet truck to be lifted or rolled onto its side to replace a caster wheel having a bottom-up replacement mode, wherein the truck sits on top of the caster wheel assembly.

FIGS. 10-12 provide illustrations relating to the handle joint device 2. The handle joint device 2 includes a handle joint seat 21 connected to a handle tube assembly H that may articulate, such as by pivoting of the handle tube assembly H upward and downward relative to the handle joint seat 21 through the joint shaft 211. The handle joint seat 21 is provided with a resilient ejector assembly, and the output end of the resilient ejector assembly is connected to the handle tube assembly H. The resilient ejector assembly is used in the handle joint device 2 to replace the traditional gas spring assembly commonly used in prior art pallet trucks.

When the handle tube assembly H pivots relative to the horizontal axis of the joint shaft 211, the output of the resilient ejector assembly is adjusted adaptively so that the resilient ejector assembly always acts on the handle tube assembly H. The handle joint seat 21 also is provided with a locking structure to lock the output of the resilient ejector assembly. When the resilient ejector assembly is locked by the locking structure, the joint shaft 211 may be disassembled directly, and the handle tube assembly H may be separated from the handle joint seat 21, making direct disassembly, installation and maintenance quick and more convenient.

The locking structure includes a pin hole arranged at each end of the output path of the resilient ejector assembly. When in use, both ends of a locking pin are inserted into pin holes and are transversely blocked in the output path of the resilient ejector assembly. The locking structure can of course be any other structure used to limit the output of the resilient ejector assembly. When the resilient ejector assembly is locked, the contact relationship between the resilient ejector assembly and the handle tube assembly H can be relieved.

The output end of the resilient ejector assembly is connected to and acts on the handle tube assembly H. The handle tube assembly H includes a handle 23 and a handle joint 24 removably connected to a lower end of the handle 23. The output end of the resilient ejector assembly is connected to the handle joint 24 of the handle tube assembly H. The resilient ejector assembly is connected to the handle joint seat 21, and the output direction of the resilient ejector assembly is fixed. The handle joint 24 is provided with a roller assembly rolling in contact with the output end of the resilient ejector assembly. The roller assembly includes a roller axle 25 positioned on the handle joint 24 and a roller 26 sleeved on the roller axle 25. The outer surface of the roller 26 is tangentially contacted by the upper end of the resilient ejector assembly. The resilient ejector assembly includes a guide column 27 fixed on the joint seat 21, a spring 28 located inside the guide column 27, and an ejector housing 29 sleeved on the guide column 27. A lower end of the spring 28 contacts an inside end face at the lower end of the guide column 27, and the upper end of the spring 28 contacts an inside end face at the upper end of the ejector housing 29.

With this structure, the handle joint 24 is connected to the lower end of the handle 23, and the output end of the ejector housing 29 is offset from the joint shaft 211 of the handle joint 24, which avoids the traditional difficulty in prior art pallet trucks of installing the upper end of an air spring module in the handle. The present structure avoids the potential contact between the typical air swing and an inner wire harness of the handle, which advantageously facilitates vehicle service and enhances vehicle safety. The resilient ejector assembly with its spring 28 replaces use of an air spring, which tends to have a high failure rate. This advantageously prolongs the service life of the handle assembly of the pallet truck and makes it more comfortable to operate.

The joint seat 21 is provided with a limit end 20 which limits the pivot range of the handle joint 24, and a buffer block 30 is fixed on a rear face of the limit end 20 to cushion the stop. With this structure, a limit end 20 is set on the joint seat 21 to directly limit the pivot swing of the handle joint 24, which provides a compact, simplified limit structure for the handle. Furthermore, the buffer block 30 is beneficial to reduce the noise otherwise caused by the assembly.

It should be noted that the above embodiments are only representative examples of the pallet truck of the present disclosure which may have many different configurations. Any equivalent to or modification of the above embodiments according to the essence of the disclosure shall be considered to be within the scope of the disclosure.

1. A pallet truck frame, comprising:
a frame body including a frame housing, a front cover and a top block;
a longitudinally extending fork connected to a front end of the frame body;
wherein the top block is connected to the rear face of the frame housing;
wherein the frame housing defines an inner cavity having a forward facing opening;
wherein the front cover is connected to and covers the forward facing opening in the frame housing;
wherein a partition wall divides the inner cavity of the frame housing into a battery cavity and an electrical components cavity;
wherein a first through hole in the partition wall connects the battery cavity and the electrical components cavity, and a second through hole through the frame housing further connects the electrical components cavity and the top block inner cavity.

2. The pallet truck frame in accordance with claim 1, wherein the partition wall extends longitudinally and divides the inner cavity into left and right cavities.

3. The pallet truck frame in accordance with claim 1, wherein a bottom of the battery cavity further comprises a battery support plate

4. The pallet truck frame in accordance with claim 3, wherein a top of the battery cavity includes an upward opening outlet that receives a battery body.

5. The pallet truck frame in accordance with claim 4, wherein a battery base is connected to the battery support plate at the bottom of the battery cavity and the battery base includes an upward facing socket.

6. The pallet truck frame in accordance with claim 5, wherein the bottom of the battery body plugs into the upward facing socket.

7. The pallet truck frame in accordance with claim 1, wherein a bottom of the electrical components cavity further comprises a support plate for a hydraulic supply system.

8. The pallet truck frame in accordance with claim 7, wherein the electrical components cavity further encloses an electrical support assembly, with the electrical support assembly comprising a base plate and electrical components arranged on the base plate.

9. The pallet truck frame in accordance with claim 8, wherein the electrical components on the base plate comprise a controller, a fuse block, an emergency stop switch, a hydraulic supply system and a loudspeaker.
